(19) United States
(12) Patent Application Publication
(10) Pub. No.: US 2017/0222546 A1
(43) Pub. Date: Aug. 3, 2017

(54) CONVERSION DEVICE

(71) Applicant: SEIKO EPSON CORPORATION, Tokyo (JP)

(72) Inventor: Takahiro NETSU, Azumino (JP)

(21) Appl. No.: 15/405,721

(22) Filed: Jan. 13, 2017

(30) Foreign Application Priority Data
Feb. 2, 2016 (JP) 2016-017721

(51) Int. Cl. H02M 3/04; H01R 24/60

(52) U.S. Cl. CPC H02M 3/04; H01R 24/60; H01R 2107/00

(57) ABSTRACT

A conversion device is configured to include a first connection port that is a connection port of a USB Type C; a second connection port that is a connection port of a USB other than the USB Type C; a third connection port that is a connection port of a power supplying wire; a communication wire that is connected to a communication line between the first connection port and the second connection port; and a power wire that is connected to a power line between the first connection port and the third connection port.

### BACKGROUND

1. Technical Field

The present invention relates to a conversion device.

2. Related Art

In the related art, a universal serial bus (USB) standard defines various types. Recently, a standard which is called the USB Type C (refer to USB Type-C Cable and Connector Specification (searched on Dec. 28, 2015), Internet (URL: http://www.usb.org/developers/usbtypec/)) is defined and is begun to spread.

If a standard incompatible with the existing standard is defined, an apparatus supporting only one standard cannot be used as an apparatus supporting only another standard.

### SUMMARY

An advantage of some aspects of the invention is to provide a technology of securing compatibility between a plurality of standards.

According to one aspect of the invention, there is provided a conversion device including a first connection port that is a connection port of a USB Type C; a second connection port that is a connection port of a USB other than the USB Type C; a third connection port that is a connection port of a power supplying wire; a communication wire that is connected to a communication line between the first connection port and the second connection port; and a power wire that is connected to a power line between the first connection port and the third connection port.

That is, the conversion device can be connected to a wire of the USB Type C by the first connection port, a wire of the USB standard other than the USB Type C by the second connection port, and a power supplying wire by the third connection port. Hence, wires of the USB standards of two types different from each other can be connected to the conversion device, and the power supplying wire can be connected to the conversion device.

In addition, since the communication wire included in the conversion device is connected to the communication line between the first connection port and the second connection port, the communication lines according to the USB Type C and the USB other than the USB Type C which are connected to each connection port are connected to each other by the conversion device. Since the power wire included in the conversion device is connected to the power line between the first connection port and the third connection port, the power lines according to the USB Type C and the USB other than the USB Type C which are connected to each connection port are connected to each other by the conversion device.

As a result, a communication line and a power line branch from the USB Type C connected to the first connection port, and the conversion device can communicate with the USB other than the USB Type C connected to the second connection port and can supply power to an electronic apparatus connected to the third connection port. Hence, the conversion device can communicate between an electronic apparatus which is connected by the USB Type C and an electronic apparatus which is connected by the USB other than USB Type C. In addition, the conversion device can transmit and receive power between an electronic apparatus which is connected by the USB Type C and an electronic apparatus which is connected to the third connection port. For this reasons, it is possible to secure compatibility between a plurality of standards.

### BRIEF DESCRIPTION OF THE DRAWINGS

The invention will be described with reference to the accompanying drawings, wherein like numbers reference like elements.

FIG. 1A is an explanatory diagram illustrating a usage aspect of a conversion device according to an embodiment of the invention, FIG. 1B is a diagram illustrating a configuration of the conversion device, and FIG. 1C to FIG. 1F are diagrams illustrating examples of a waveform of a signal.

FIG. 2A is a flowchart of a control circuit, and FIG. 2B is a diagram illustrating a configuration of another conversion device.

### DESCRIPTION OF EXEMPLARY EMBODIMENTS

Here, embodiments of the invention will be described according to the following order.
(1) Usage Aspect of Conversion Device
(1-1) Configuration of Conversion Device
(2) Processing of Control Circuit
(3) Another Embodiment

### (1) Usage Aspect of Conversion Device

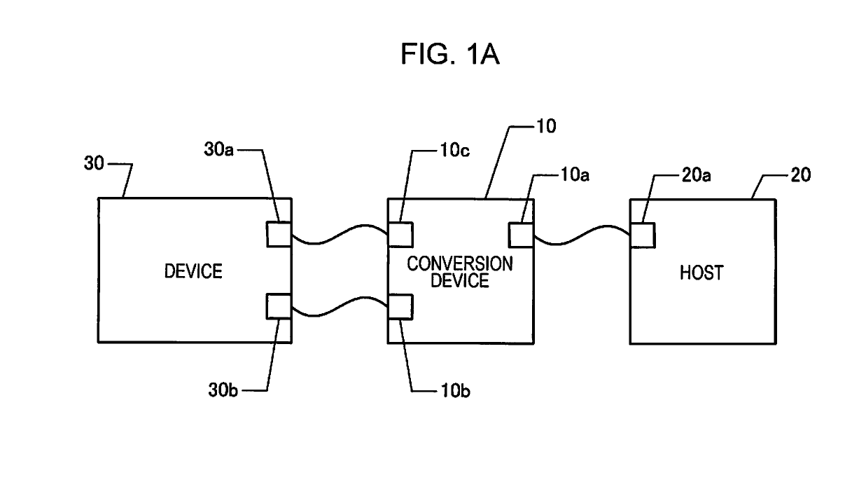

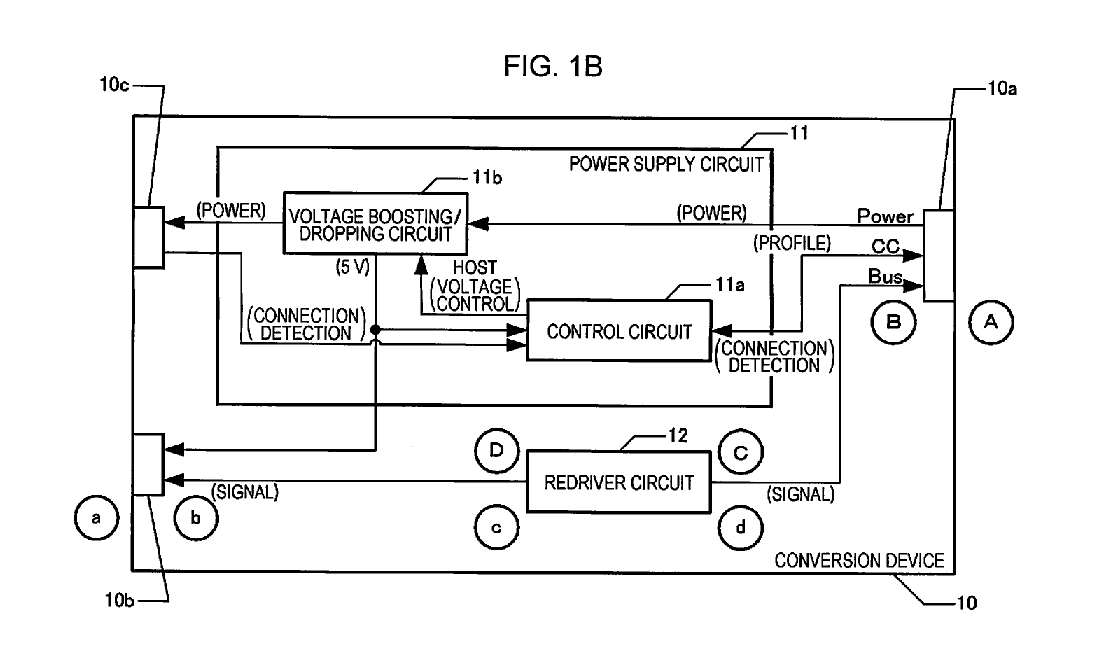

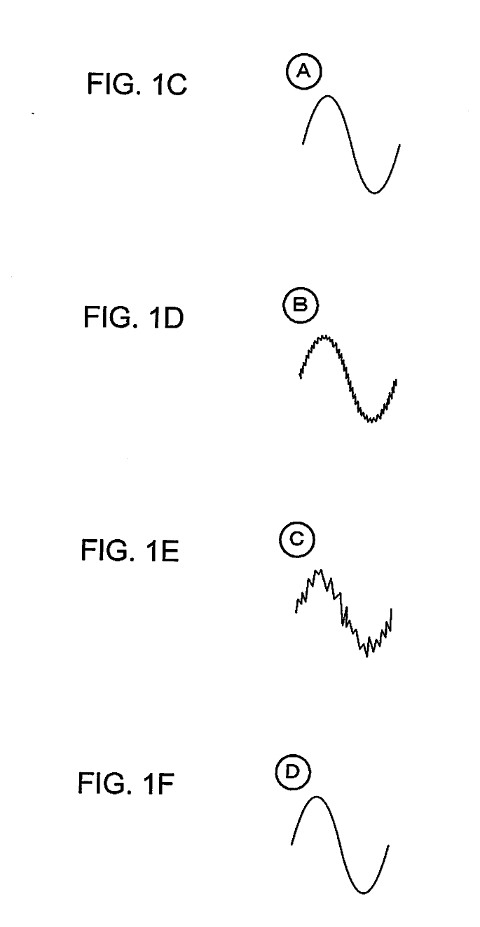

FIG. 1A is an explanatory diagram illustrating a usage aspect of a conversion device 10 according to an embodiment of the invention. The conversion device 10 according to the present embodiment is connected to a host 20 and a device 30. The conversion device 10 is connected to the host 20 according to a standard of USB Type C. That is, the conversion device 10 includes a first connection port 10a which is a connection port of the USB Type C, and the host 20 includes a connection port 20a of the USB Type C. Hence, one connector of the USB Type C which is included in a wire of the USB Type C is connected to the first connection port 10a, and the other connector is connected to the connection port 20a, and thereby, the conversion device 10 is connected to the host 20 by the wire of the USB Type C.

The conversion device 10 is connected to the device 30 in accordance with a standard of USB Type A. That is, the conversion device 10 includes a second connection port 10b which is a connection port of the USB Type A, and the device 30 includes a connection port 30b of the USB Type A. Hence, one connector of the USB Type A which is included in a wire of the USB Type A is connected to the second connection port 10b, and the other connector is connected to the connection port 30b, and thereby, the conversion device 10 is connected to the device 30 by the wire of the USB Type A.

Furthermore, the conversion device 10 is connected to the device 30 by a power line. That is, the conversion device 10 includes a third connection port 10c which is a connection port of a power supplying wire, and the device 30 includes a connection port 30a of the power supplying wire. Hence, one connector of the power supplying wire is connected to the third connection port 10c of the conversion device 10, the other connector is connected to the connection port 30a, and thereby, power can be supplied from the conversion device 10 to the device 30.

### (1-1) Configuration of Conversion Device

FIG. 1B is a diagram illustrating a configuration of the conversion device 10 that is used together with the host 20 and the device 30 which can perform communication corresponding to a SuperSpeed standard. The conversion device 10 includes a power supply circuit 11 and a redriver circuit 12. The power supply circuit 11 has a function of generating power which is supplied to the device 30 connected to the third connection port 10c, based on the power which is supplied from the host 20 connected to the first connection port 10a, and includes a control circuit 11a and a voltage boosting/dropping circuit 11b.

The control circuit 11a includes a wire which is connected to the first connection port 10a (by a CC pin), and wires which are connected to the voltage boosting/dropping circuit 11b and the third connection port 10c. The control circuit 11a is a circuit (for example, circuit including a CPU, a RAM, a ROM, and the like) which performs a predetermined function in accordance with a predetermined order. The control circuit 11a can detect whether or not a connector is inserted into the third connection port 10c through a wire connected to the third connection port 10c.

Furthermore, the control circuit 11a can output profile data of power to the host 20 through the wire connected to the first connection port 10a. That is, in the present embodiment, a storage medium (not illustrated) included in the control circuit 11a stores the profile data in accordance with a required specification of the device 30 in advance. If the control circuit 11a outputs the profile data to the first connection port 10a, the host 20 connected to the first connection port 10a acquires the profile data. Then, the host 20 outputs power that the profile data indicates from the connection port 20a. As a result, power is input from the first connection port 10a through the wire of the USB Type C, and is supplied to the voltage boosting/dropping circuit 11b.

Hence, according to the present embodiment, it is possible to supply the profile data that the host 20 of the USB Type C usually requires to perform power supplying (Power Delivery) from the conversion device 10. Accordingly, although the device 30 does not support the standard of USB Type C (Power Delivery), the device 30 can instruct the conversion device 10 to output the power to the host 20.

In the embodiment, the profile data is defined according to the required specification of the device 30, a configuration is provided in which a voltage closest to a voltage defined in the required specification of the device 30 is output from the host 20 and loss of voltage conversion of the voltage boosting/dropping circuit 11b which will be described below is prevented. For example, in a case where a voltage defined in the required specification of the device 30 is 48 V, the profile is defined in advance such that 20 V which is an upper limit value of a voltage is output from the host 20, and the profile is stored in the control circuit 11a.

Furthermore, the control circuit 11a is connected to the voltage boosting/dropping circuit 11b by a communication line and a power line, and the control circuit 11a can output a control signal instructing an output or the like of power (for example, value of voltage) to the voltage boosting/dropping circuit 11b through the communication line. In addition, the control circuit 11a receives power (DC power of 5 V in the present embodiment) for driving the control circuit 11a through the power line of the voltage boosting/dropping circuit 11b.

The voltage boosting/dropping circuit 11b generates power of a voltage stored in response to the profile data, based on the power supplied from the host connected to the first connection port 10a. In the present embodiment, the voltage boosting/dropping circuit 11b includes a wire which is connected to the first connection port 10a (by a Power pin), a wire which is connected to the third connection port 10c, and a wire which is connected to the control circuit 11a.

The voltage boosting/dropping circuit 11b generates power in which a voltage is boosted or dropped based on the power that is input through the wire connected to the first connection port 10a. In the present embodiment, a voltage or the like of the output power is determined based on an instruction from the control circuit 11a. In the present embodiment, a storage medium (not illustrated) included in the control circuit 11a stores a required specification of power of the device 30 in advance.

In a case where the power which is supplied from the first connection port 10a on the basis of the profile data is different from the power that the device 30 requires, the control circuit 11a instructs the voltage boosting/dropping circuit 11b to generate the latter power from the former power. As a result, the voltage boosting/dropping circuit 11b generates power according to the required specification of the device 30 from, for example, an input voltage. In a case where the power which is supplied from the first connection port 10a on the basis of the profile data is equal to the power that the device 30 requires, the voltage boosting/dropping circuit 11b does not convert a voltage.

In the embodiment, the control circuit 11a can instruct the voltage boosting/dropping circuit 11b to start output of power. As described above, the control circuit 11a functions as a connection detecting circuit which detects whether or not a connector is connected to the third connection port 10c, and thus, if the control circuit 11a detects that the connector is connected to the third connection port 10c, the control circuit 11a instructs the voltage boosting/dropping circuit 11b to start output of power. As a result, power is supplied to the device 30 connected to the third connection port 10c through the connector connected to the third connection port 10c and the wire extending from the connector. According to the configuration, it is possible to prevent a voltage from being applied to the third connection port 10c in a state where a wire which has to receive power is not connected to the conversion device 10.

In addition, according to the aforementioned configuration, it is possible to output power according to the required specification of the device 30 from the conversion device 10. In addition, even in a case where the required specification of the power of the device 30 exceeds the specification of USB Type C (for example, in a case where a voltage value exceeds 20 V which is an upper limit value of USB Type C), the conversion device 10 can supply the power of the specification that the device 30 requires. The voltage boosting/dropping circuit 11b can generate DC power of a default voltage (5 V in the present embodiment), based on the power which is input through the wire connected to the first connection port 10a, and output the voltage. The generated power is supplied to the control circuit 11a and the second connection port 10b.

The redriver circuit 12 is connected to the first connection port 10a and the second connection port 10b through communication lines, and shapes a waveform of a signal which is transmitted from the first connection port 10a to the second connection port 10b (or transmitted from the second connection port 10b to the first connection port 10a). It is preferable that the redriver circuit 12 be applied to a signal whose frequency is high and frequency loss cannot be neglected, for example, a signal defined by a SuperSpeed standard.

Specifically, in a case where a high frequency signal with a waveform illustrated in FIG. 1C is input to an A side of the first connection port 10a illustrated in FIG. 1B from the host 20, the signal can have a waveform illustrated in FIG. 1D on a B side of the first connection port 10a illustrated in FIG. 1B and a waveform of the signal can collapse like the waveform illustrated in FIG. 1E immediately before (on a C side illustrated in FIG. 1B) the redriver circuit 12, and such a change of the waveform of the signal is noticeable in a high frequency signal. However, if the redriver circuit 12 illustrated in FIG. 1B exists, a signal which is deformed as illustrated in FIG. 1E can be shaped as a waveform illustrated in FIG. 1F to be output on a D side of FIG. 1B.

Meanwhile, in a case where a high frequency signal with a waveform illustrated in FIG. 1C is input to an a side of the second connection port 10b illustrated in FIG. 1B from the device 30, the signal can have a waveform illustrated in FIG. 1D on a b side of the second connection port 10b illustrated in FIG. 1B and a waveform of the signal can collapse like the waveform illustrated in FIG. 1E immediately before (on a c side illustrated in FIG. 1B) the redriver circuit 12, and such a change of the waveform of the signal is noticeable in a high frequency signal. However, if the redriver circuit 12 illustrated in FIG. 1B exists, a signal which is deformed as illustrated in FIG. 1E can be shaped as a waveform illustrated in FIG. 1F to be output on a d side of Fig. 1B. Hence, according to the present embodiment, a signal defined by the SuperSpeed standard that is a high frequency signal can be appropriately transmitted between the host 20 and the device 30, and thereby, appropriate communication can be performed.

As described above, the conversion device 10 can relay communication between the device 30 and the host 20 which are connected to the second connection port 10b. Hence, the conversion device 10 can perform communication between the host 20 which uses the USB Type C and the device 30 which uses the USB other than the USB Type C. In addition, the conversion device 10 can supply power from the host 20 to the device 30 connected to the third connection port 10c, and can supply power to the device 30 without using an AC adapter or the like. In addition, the conversion device 10 converts power supplied from the host 20 into power which can be used for the device 30, and thus, even in a case where standards of the USB for the host 20 and the device 30 are different from each other, power can be supplied from the host 20 to the device 30. For this reasons, according to the conversion device 10, compatibility between a plurality of standards can be secured.

### (2) Processing of Control Circuit

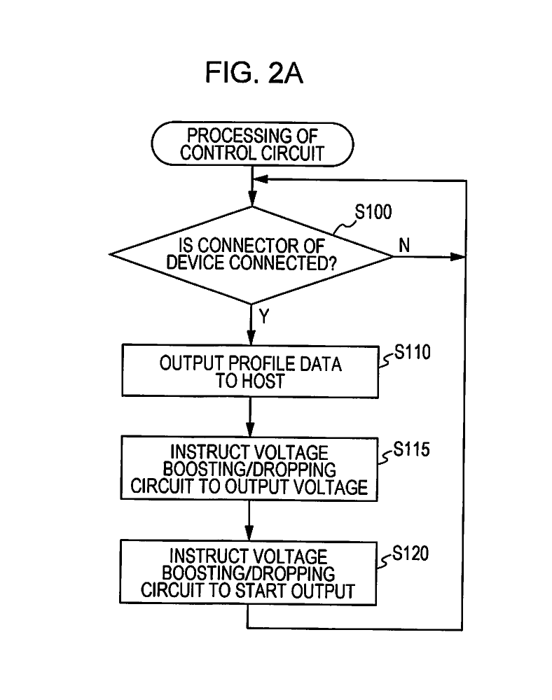

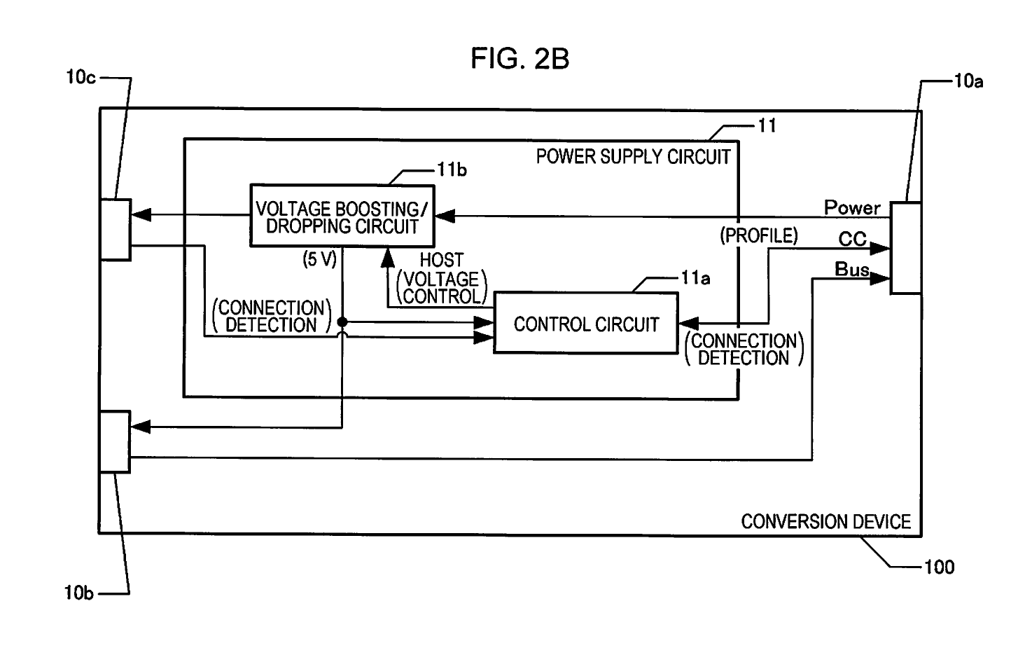

FIG. 2A is a flowchart illustrating processing of the control circuit 11a. In the present embodiment, the host 20 is connected to the conversion device 10, default power is supplied from the host 20 through the first connection port 10a, DC power of 5 V is supplied from the voltage boosting/dropping circuit 11b to the control circuit 11a, based on the power, and thereby, the control circuit 11a starts processing illustrated in FIG. 2A. In addition, here, it is assumed that an example is used in which DC power of 48 V is defined as the required specification of the power of the device 30.

In the processing, the control circuit 11a detects whether or not a connector of the device 30 is connected to the third connection port 10c (step S100). In step S100, in a case where it is not determined that the connector of the device 30 is connected to the third connection port 10c, the control circuit 11a repeats determination of step S100 at a constant time.

In step S100, in a case where it is determined that the connector of the device 30 is connected to the third connection port 10c, the control circuit 11a outputs the profile data to the host 20 with reference to a storage medium which is not illustrated (step S110). If the host 20 acquires the profile data, the host 20 outputs power that the profile data indicates to the conversion device 10. In the present example, the device 30 requires DC power of 48 V, and thus, the profile data indicates power (5 A) of 20 V that is an upper limit voltage. Hence, if the host 20 acquires the profile data, DC power of 20 V and 5 A is supplied to the first connection port 10a through a wire of USB Type C.

Subsequently, the control circuit 11a instructs the voltage boosting/dropping circuit 11b to output a voltage (step S115). That is, the control circuit 11a outputs a control signal to the voltage boosting/dropping circuit 11b such that power according to the required specification of the device 30 is output, with reference to the storage medium which is not illustrated. For example, in an example in which the device 30 requires DC power of 48 V, the control circuit 11a instructs the voltage boosting/dropping circuit 11b to output the DC power of 48 V. As a result, the voltage boosting/dropping circuit 11b generates power according to the required specification of the device 30.

Subsequently, the control circuit 11a instructs the voltage boosting/dropping circuit 11b to start output (step S120). As a result, the voltage boosting/dropping circuit 11b outputs power according to the required specification of the device 30 from the third connection port 10c. Subsequently, the control circuit 11a repeats processing subsequent to step S100. However, step S100 is repeatedly performed, in a case where it is not determined that the connector of the device 30 is connected to the third connection port 10c, that is, in a case where the connector of the third connection port 10c is pulled out, the control circuit 11a stops conversion of the power and output of the power of the voltage boosting/dropping circuit 11b, and repeats the processing of step S100.

### (3) Another Embodiment

The aforementioned embodiment is an example for performing the invention, and, as long as the conversion device has a configuration in which communication lines of the USB according to standards different from each other are connected and power is transmitted and received through a power line of the USB according to one standard, various other embodiments can be employed.

For example, the conversion device 10 includes the redriver circuit 12, but if a signal to be transmitted is a signal which can neglect influence of high frequency loss, for example, a signal according to a High Speed standard, the redriver circuit 12 can be omitted. FIG. 2B illustrates a configuration of a conversion device 100 which is configured by omitting the redriver circuit 12 from the conversion device 10 illustrated FIG. 1B. In the configuration illustrated in the FIG. 2B, configuration elements to which the same symbols or reference numerals as those illustrated in FIG. 1B are attached have the same configuration as the configuration elements illustrated in FIG. 1B.

As such, although the redriver circuit 12 is omitted, a signal can be transmitted without shaping a waveform as long as the signal is a low frequency signal. Hence, as illustrated in FIG. 2B, power which is supplied from the host 20 is converted according to necessity to be supplied to the device 30 by using the power supply circuit 11 in the same manner as in FIG. 1B, and thereby, it is possible to provide the conversion device 100 which can secure compatibility between a plurality of standards.

Furthermore, a first connection port may be a connection port of the USB Type C. Hence, a shape or a terminal of an insertion portion of a connector may be disposed such that a connector of the USB Type C is connected and thereby communication is performed (power may be able to be transmitted and received). Alternatively, a direct connection to a connection port of USB Type C of the host 20 may be performed without passing through a cable.

A second connection port may be a connection port of the USB other than the USB Type C. Hence, a shape or a terminal of an insertion portion of the connector may be disposed such that a connector according to a USB standard other than USB Type C is connected, and thereby, communication and transmission/reception of power can be performed. For example, the USB Type A or B, the mini-USB Type A, B or AB, micro-USB Type A, B, or AB, or the like can be used as the USB standard other than the USB Type C. In addition, a direct connection to a connection port of the USB of the device 30 may be performed without passing through a cable.

A third connection port may be a connection port of a power supplying wire. That is, power may be able to be transmitted and received between an electronic apparatus and a conversion device which are connected to the connection port. A shape or a terminal of the third connection port can have aspects according to various standards. A direct connection to the, connection port of the power supplying wire of the device 30 may be performed without passing through a cable.

A communication wire may be able to connect a communication line between the first connection port and the second connection port. That is, a wire may be formed such that communication is performed between an electronic apparatus of the USB Type C connected to the first connection port and an electronic apparatus of the USB other than the USB Type C connected to the second connection port. Of course, the communication wire may include various circuits, for example, a redriver (repeater) circuit or the like which shapes a waveform of a signal for communication according to the SuperSpeed standard or the like.

The power wire may be able to connect a power line between the first connection port and the third connection port. That is, the wire may be formed such that power is transmitted and received between the electronic apparatus of the USB Type C connected to the first connection port and the electronic apparatus connected to the third connection port. Of course, the power wire may include various circuits such as a power supply circuit for generating power according to specifications (voltage, current, and the like) of power necessary for the electronic apparatus connected to the third connection port. In addition, as long as the host 20 can supply power according to the specification of the power that the device 30 requires, the first connection port may be directly connected to the third connection port through a power line, and may pass through only a switch which switches ON/OFF of supplying of power, without using the voltage boosting/dropping circuit 11b.

Specifically, the power wire can employ a configuration including a power supply circuit which generates power that is supplied to a device connected to the third connection port, based on power supplied from the host connected to the first connection port. According to the configuration, a conversion device converts power supplied from the host into power which can be used for the device, and thus, it is possible to supply power from the host to the device, even in a case where standards of the USB for the host and the device are different from each other.

Furthermore, a configuration may be provided in which the power supply circuit outputs profile data of power the host through a wire connected to the first connection port. According to the configuration, it is possible to supply the profile data that the host of the USB Type C usually requires to perform power supplying (Power Delivery) from a conversion device. Accordingly, although the device does not support the standard of USB Type C (Power Delivery), the device can instruct the conversion device to output power to the host.

The profile data may be stored in a storage medium included in the conversion device, default profile data may be stored, and the profile data may be able to be rewritten based on an operation of a user, communication with the device, or the like. For example, in the aforementioned configuration illustrated in FIG. 1B, the control circuit 11a or the like is configured to include a rewritable EEPROM or the like, and the EEPROM or the like is configured to store profile data. In the configuration, if the profile data can be rewritten based on an operation of a user, instruction of an electronic apparatus connected to the conversion device 10, or the like, it is possible to provide the conversion device 10 corresponding to various devices 30.

Furthermore, the power supply circuit may include a voltage boosting/dropping circuit which generates power of a voltage stored corresponding to the profile data, based on the power supplied from the host connected to the first connection port. According to the configuration, even in a case where the required specification of the power of the device exceeds the specification of USB Type C (for example, in a case where a voltage value exceeds 20 V that is an upper limit of the standard of the USB Type C), it is possible to supply power of a specification that the device requires from a conversion device. The required specification of the power that the device requires may be stored in a storage medium that the conversion device includes, default required specification may be stored, and the required specification may be able to rewritten, based on an operation of a user, communication of a device, or the like. In addition, a voltage according to an input may be generated by inputting a type of a device which is connected to a user or a voltage value which is output, by providing a switch to the conversion device 10, or the like.

Furthermore, the power supply circuit may include a configuration in which a connection detecting circuit which detects whether or not a connector is connected to the third connection port is provided and when the connection detecting circuit detects that the connector is connected to the third connection port, the power supply circuit starts supplying of power to the third connection port. According to the configuration, it is possible to prevent a voltage from being applied to the third connection port in a state where a wire which has to receive power is not connected to the conversion device.

Furthermore, as described above, a technology of transmitting and receiving power by using a power line of the USB according to one standard in a state where communication lines of the USB according to different standards are connected to the conversion device can also be realized as a method.

What is claimed is:

1. A conversion device comprising:
a first connection port that is a connection port of a USB Type C;
a second connection port that is a connection port of a USB other than the USB Type C;
a third connection port that is a connection port of a power supplying wire;
a communication wire that is connected to a communication line between the first connection port and the second connection port; and
a power wire that is connected to a power line between the first connection port and the third connection port.

2. The conversion device according to claim 1,
wherein the power wire includes a power supply circuit that generates power which is supplied to a device that is connected to the third connection port, based on power that is supplied from a host which is connected to the first connection port.

3. The conversion device according to claim 2,
wherein the power supply circuit outputs profile data of power to the host through a wire that is connected to the first connection port.

4. The conversion device according to claim 3,
wherein the power supply circuit includes a voltage boosting/dropping circuit that generates power of a voltage which is stored corresponding to the profile data, based on power that is supplied from the host which is connected to the first connection port.

5. The conversion device according to claim 2,
wherein the power supply circuit includes a connection detecting circuit that detects whether or not a connector is connected to the third connection port, and starts supplying of power to the third connection port in a case where the connection detecting circuit detects that the connector is connected to the third connection port.

6. The conversion device according to claim 1,
wherein the communication wire includes a redriver circuit which shapes a waveform of a signal that is transmitted through the communication line.
